(19) United States
(12) Patent Application Publication
(10) Pub. No.: US 2012/0217153 A1
(43) Pub. Date: Aug. 30, 2012

(54) Self-Tuning Power Supply

(76) Inventors: Richard A. Brown, Vancouver, WA (US); John R. Wyss, Woodinville, WA (US)

(21) Appl. No.: 13/036,467

(22) Filed: Feb. 28, 2011

(51) Int. Cl. H02M 5/458; C25B 15/00; H02P 23/00; H05B 37/02; H05B 41/36

(52) U.S. Cl. 204/229.7; 363/37; 315/291; 318/700

(57) ABSTRACT

A pulse width encoded switching power supply, which may be electrically connected to an electroluminescent (EL) material is described. The power supply exploits both mechanical and electronic resonance principles to provide maximum emission from EL phosphor crystals using an LC tank circuit power supply design at specific frequency to maximize photon emission. Other possible applications are also described.

### BACKGROUND

Power supplies used to power certain devices, such as electroluminescent (EL) backlights, generally need to provide additional power to increase brightness. Boosting the power may provide a brighter backlight, but it generally shortens the longevity of the EL.

In other applications it is also often necessary to increase power to increase the output of a device.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The instant application relates to a power supply suitable for powering devices such as an electroluminescent (EL) backlight. In one embodiment, the power supply uses an inductor-capacitor (LC) tank circuit resonance designed to power an inorganic electroluminescent material, a power source, an electronic switching circuit, and a frequency generator and a pulse width encoder. This may allow increased brightness without a need for increasing the power provided.

### BRIEF DESCRIPTION OF THE DRAWINGS

These and other features and advantages of a self-tuning power supply will now be described with reference to drawings of certain embodiments, which are intended to illustrate and not to limit the instant application.

The present invention is described in detail below with reference to the attached drawing figures, wherein:

FIG. 1 shows a block diagram of one embodiment of a power supply with an LC tank circuit resonance design.

FIG. 2 shows one example of a power supply with an LC tank circuit resonance design.

FIG. 3 shows another example of a power supply with an LC tank circuit resonance design.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In the following detailed description, references are made to the accompanying drawings that form a part hereof, and which show by way of illustration specific embodiments or examples. Referring now to the drawings, in which like numerals represent like elements through the several figures, aspects of a self-tuning power supply will be described.

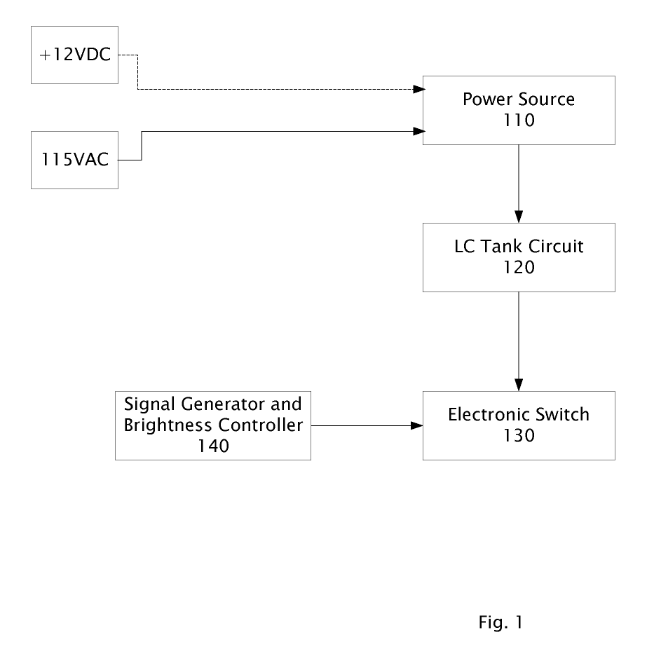

FIG. 1 shows a block diagram of one embodiment of a power supply with an LC tank circuit resonance design. In this embodiment of the adjustable and precision tuned pulse width encoded EL tank circuit switching power supply discussed herein, there are four components involved. These are 1) an unregulated power source 110; 2) an LC tank circuit 120; 3) an electronic switching circuit 130; and 4) a frequency generator with built in pulse-width encoder, used in this sample embodiment as a signal generator and brightness controller 140.

An equation for determining an output frequency of an LC tank circuit 120 has three parameters: the frequency for stimulating the LC oscillator, measured in hertz or cycles per second; the inductance, measured in henries; and the capacitance, measured in farads.

$$f = \frac{1}{2 π \sqrt{LC}}$$

Two of these three parameters may be determined in advance; frequency (f) may be preselected, and may be, for example, between 60 hz and 20 khz for EL backlight embodiments. The capacitance (C) of the EL C1 may be measured empirically using a capacitance meter. The value of the inductor (L) needed to obtain a particular resonance frequency in a specific LC tank circuit 120 may be calculated to provide a maximum brightness capability of a sheet of EL after fine tuning the frequency and duty cycle.

To accommodate our EL LC tank circuit's 120 external stimulus requirements, a switching circuit 130, an external adjustable power source 110, to supply adjustable voltage and current to the LC tank circuit 120 and to allow the EL brightness to be variable, and a precision frequency controlled generator circuit 140, to maintain resonant harmonics in the LC tank circuit.

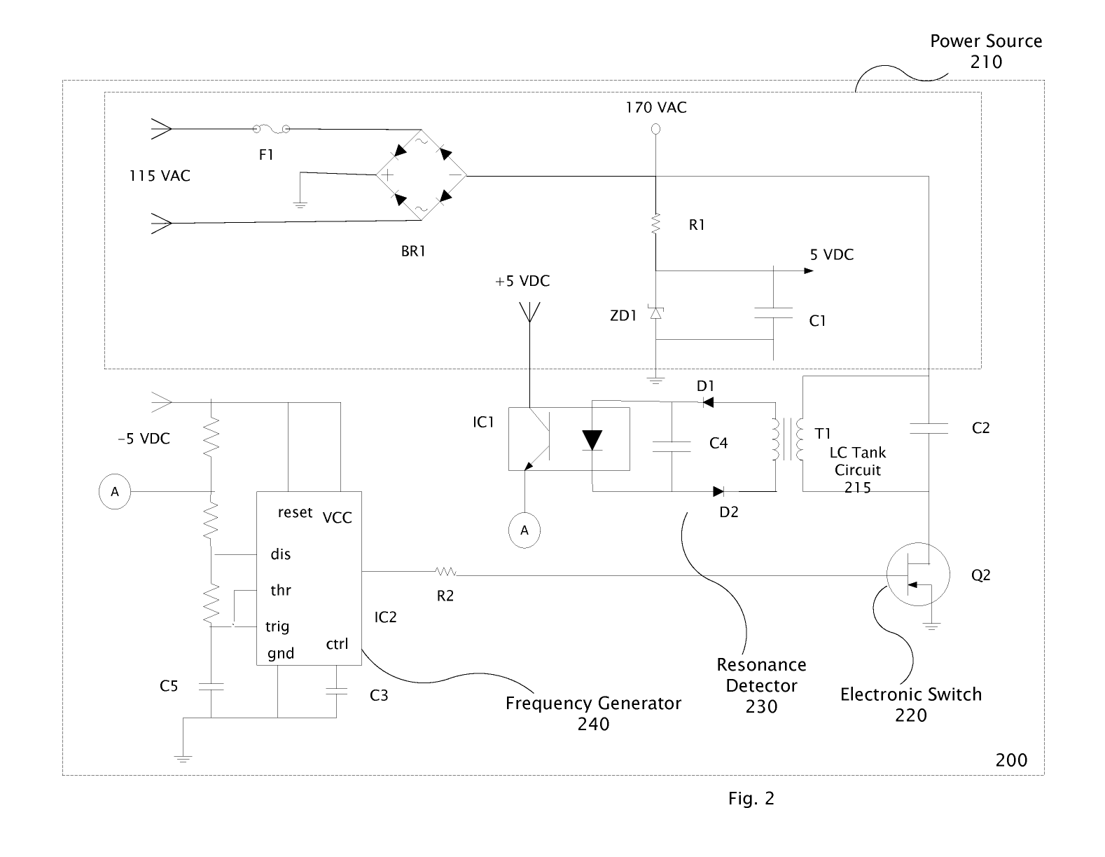

FIG. 2 illustrates a circuit diagram for one possible embodiment of the circuitry for a self-tuning power supply 200. As shown, a power source 210 may be designed to be variable and capable of producing up to 1000 volts direct current (VDC) with the current source from external power possibly being less than one amp depending on the load factor, which in this example is based on the size of an EL sheet (C2). A frequency generator may be designed to operate at a specific fixed and predetermined frequency by sending either a square wave or a sine wave to the electronic switch in order to maintain LC tank circuit resonance. A predetermined frequency will depend on the size of the load (C2) and on the amount of brightness required by the EL for the specific application being designed. An electronic switching circuit may pull the minimized current flowing through the LC tank circuit to ground at the correct time. The entire power supply may be a low power circuit since the LC tank circuit loading effect is minimal at the resonant frequency and the output of the power supply source supplies the high side (non-switching side) of the LC tank circuit (low current but high in voltage). The LC tank circuit may be capable of illuminating EL material with applied DC voltages between 50 VDC and 1000 VDC and may be designed to operate from a 12 VDC incoming power source for portability purposes. Power consumption for the entire power supply system will be low (with the LC tank circuit operating at the resonate frequency) with only about 0.5 mA/sqcm (for ˜300 cd/m2 brightness) and about 0.7 mA/sqcm (for ˜500 cd/m2 brightness) being drawn from the power supply depending on the on-time of the electronic switching circuit which is controlled by the duty cycle (duration) of the pulse width encoder (part of the time based frequency generator circuit). For example, a EL sheet with dimensions of say 20″×35″ (a 40″ LCD television back light) operating at about 200 cd/m2 would consume about 0.7 amps (14 watts) and be calculated as follows:

(700 sqin)/(0.3 scm/sqin)=2,333 sqcm·2,333 sqcm*0.3 mA/sqcm=700 mA=0.7 A. And the wattage would be: 0.7 A*200V=14 W.

One skilled in the art will recognize that there are numerous design alterations and possibilities for each of these power supply blocks described above, a few of which are described below:

### Unregulated Power Source 210:

FIG. 2 illustrates one embodiment of power source 210. An example of a parts list for this power source would be:
F1: 1 amp, 250V fuse
BR1: bridge rectifier with the four diodes being 1N4004
R1: 10 Kohm, ½ w
ZD1: 1N5224, ½w
C1: 10 uf, 10V

One skilled in the art will realize that other components may be used to provide similar functionality.

### LC Tank Circuit 215:

One embodiment of the LC tank circuit 215 uses a step-down transformer, with higher resistance wire selected for use as an inductor T1. A lower resistance wiring may be selected to provide a voltage suitable for a resonance detector 230.

A load for this embodiment may be an EL C2. Other loads beside an EL may also be driven by such a circuit.

One skilled in the art will realize that other components may be used to provide similar functionality.

### Resonance Detector 230:

In the example embodiment illustrated in FIG. 2, IC1 is a LTV-817S-TAI optocoupler, which isolates the LC tank circuit 215 from the frequency generator 240. The current flowing thru the inductor's primary winding sets up a specific voltage across it's secondary winding which is rectified and filtered. This DC voltage controls the conduction of the optocoupler which in turn changes the resistance of the output stage of the optocoupler. In this embodiment the current flow thru the inductor's primary winding is maximum at resonance, as is the DC voltage developed across the secondary. This peaked DC voltage corresponds to a specific resistance value which corresponds to a specific output frequency from the frequency generator. Any non-resonant feedback resistance values will be less, thus altering the frequency. The frequency generator 240's frequency will continue to change value until a stable voltage is detected in the optocoupler circuit, which is when a point of resonance is reached. One skilled in the art will realize that other components may be used to provide similar functionality.

### Electronic Switch 220:

Various embodiments for an electronic switch 220 may include, by way of example and not limitation, a MOSFET, FET, SCR, TRIAC or fast switching BJT with a criteria being that the device be capable of handling the power consumption of a device being powered. It is this circuit which may supply the current sink to ground to pulsate the EL tank circuit. As with the components mentioned earlier, any higher power device will work so long as the minimum power constraints are satisfied. Heating up of this device may be of concern, in which case input impedance, ability to switch quickly, and power dissipation may be considered. R2 may limit the current draw on the timer circuit in order to ensure minimum stress on the output stage of whatever timer based circuit is used. One skilled in the art will realize that other components may be used to provide similar functionality.

### Frequency Generator 240:

A timer chip may be used as a time-based frequency generator 240 with a built-in pulse-width encoder:

A 555 timer IC may be used, by way of example and not limitation, since it may handle voltages up to about 15 VDC and may be designed to accommodate frequencies into the megahertz range with duty cycles up to 50%. In this example embodiment, values for R2, R3 and C3 are calculated per the equations that are supplied with the 555 timer IC's data sheet. Either R2 or R3 may be a variable potentiometer in order to allow for variation of the output's waveform. This allows such a circuit to be used as a pulse width encoder and it may be used to vary the on-time for the switching device, which may result in varying the brightness of the EL material. There are numerous oscillator timer circuits and IC's that duplicate the function of the 555 timer including SW programmable timers such as the CD4541 BE programable IC or the U2102B oscillator timer IC for example. Virtually any waveform can be used to switch a particular type of switching device but a square wave is the most commonly used since the pulse duration can be easily varied using any number of pulse width encoder designs. However, other embodiments may use different shapes or a combination of shapes for waveforms. One skilled in the art will realize that other components may be used to provide similar functionality.

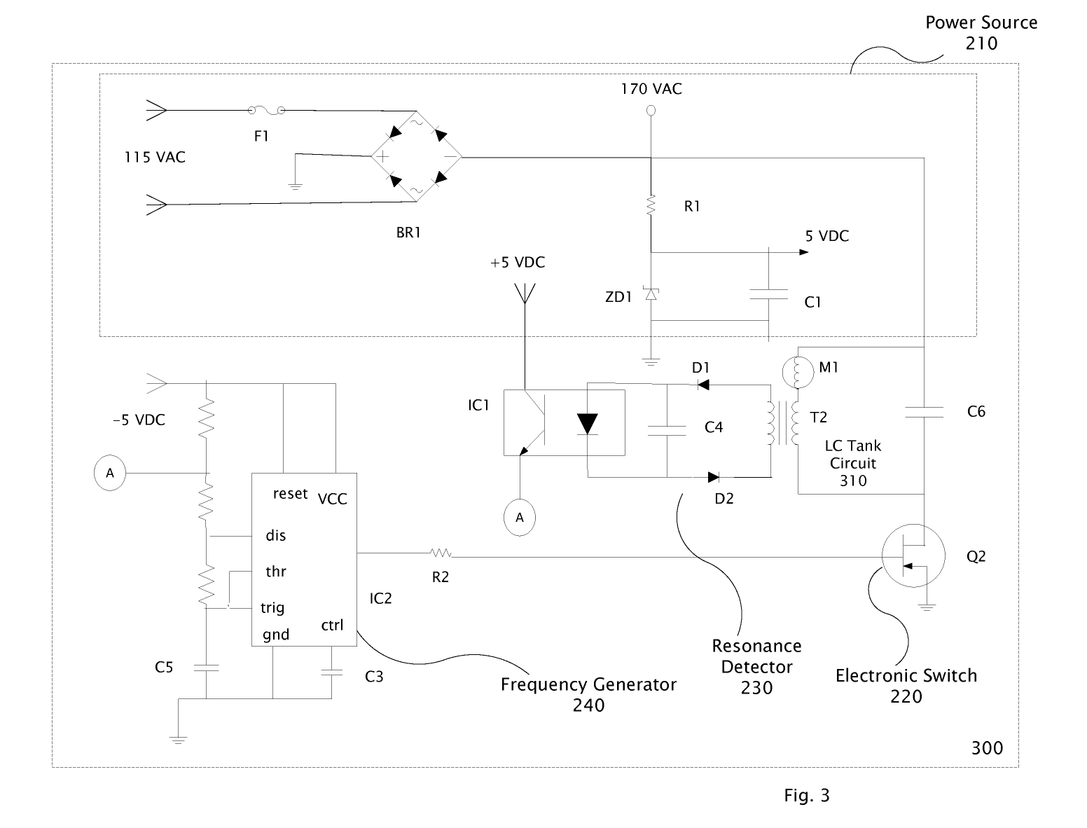

FIG. 3 shows another example of a self-tuning power supply 300 with an LC tank circuit resonance design. The self-tuning power supply 300 in this example is powering an alternating current (AC) induction Motor M1. The Motor M1 is placed in series with transformer T2 in LC Tank Circuit 310. Transformer T2 will operate as a feedback network. Capacitor C6 may be a non-polar parallel plate capacitor. The current flowing through Motor M1 also passes through Transformer T2, which may then, in conjunction with Resonance Detector 230, develop a correction voltage to adjust the frequency of the LC Tank Circuit 310, which may optimize the current flow through Motor M1, even as component specifications and Motor M1 load factors vary over time. One skilled in the art will realize that other components may be used to provide similar functionality.

The examples used in this application are for illustrative purposes only, and are not meant to restrict the scope of this application. The examples have primarily used AC induction motors and EL devices, such as EL backlights as devices that may be powered by a self-tuning power supply. However, other devices may also be powered by a self-tuning power supply as described herein. For example, a device to perform electrolysis may be run most efficiently when at its resonant frequency. Similarly, gas-discharge lamps may work best with a self-tuning power supply, which may adjust the operating frequency over time as components specifications change with temperature or wear over time. Other devices may also work more efficiently when operated at a resonant frequency.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

1. A power supply comprising:
an unregulated power source;
an inductance-capacitance (LC) resonant tank circuit, a device to be powered by the circuit providing at least part of the capacitance;
an electronic switching circuit; and
a time-based frequency generator with built in pulse width encoder.

2. The power supply of claim 1 wherein the time-based frequency generator with built in pulse width encoder comprises a 555 integrated circuit.

3. The power supply of claim 1 wherein the device to be powered is a water-to-oxygen-and-hydrogen separator.

4. The power supply of claim 1 wherein the device to be powered is an electroluminescent lighting device.

5. The power supply of claim 5 wherein the electroluminescent lighting device is a backlight for an LCD screen.

6. The power supply of claim 1 wherein the device to be powered is an alternating current induction motor.

7. The power supply of claim 1 wherein the device to be powered is a gas-discharge lamp.
